(19) United States
(12) Patent Application Publication
(10) Pub. No.: US 2026/0142442 A1
(43) Pub. Date: May 21, 2026

(54) DEVICE FOR USE WITH A SUSPENDED CABLE

(71) Applicant: BRITISH TELECOMMUNICATIONS PUBLIC LIMITED COMPANY, London Greater London (GB)

(72) Inventor: Trevor MORSMAN, London Greater London (GB)

(21) Appl. No.: 19/121,253

(22) PCT Filed: Sep. 8, 2023
(86) PCT No.: PCT/EP2023/074718

§ 371 Date: Apr. 15, 2025

(30) Foreign Application Priority Data
Oct. 31, 2022 (GB) 2216063.4

(51) Int. Cl. H02G 1/02; B61B 3/02

(52) U.S. Cl. CPC H02G 1/02; B61B 3/02

(57) ABSTRACT

A device (100) for traversing a suspended cable (110) anchored at each end, and the device comprising: an open non-linear channel (130) for receiving, by a slotting action, the suspended cable, said non-linear channel defining a minor segment (165-2); a motor (135); and a drive mechanism (140), powered by the motor, arranged within the minor segment so as to contact the suspended cable when received by the non-linear channel and thereby to drive the device along the suspended cable.

### FIELD OF INVENTION

The present invention relates to a device for traversing a suspended cable, and in particular to a device comprising a mounting arrangement for mounting on a suspended cable.

### BACKGROUND

In telecommunications networks, suspended cables are typically suspended overhead along poles or other structures, and may be referred to as dropwires (or aerial or overhead cables).

Occasionally, maintenance must be performed upon suspended cables, for example so as to: clear vegetation; apply a protective sheath; and/or replace a suspended cable entirely.

However, such maintenance may present challenges, especially when continuity of telecommunications services is required and when dropwires are deployed across roads, which may need to be closed. When dropwires span difficult terrain (e.g. highly vegetated areas, rivers, or ravines), access may be difficult and/or dangerous. Furthermore, the risk of falling equipment presents a health and safety hazard.

It is therefore an aim of the present invention at least to help alleviate some of the aforementioned problems.

### STATEMENTS OF INVENTION

According to a first aspect of the present invention, there is provided: a device for traversing a suspended cable anchored at each end, and the device comprising: an open non-linear channel for receiving, by a slotting action, the suspended cable, said non-linear channel defining a minor segment; a motor; and a drive mechanism, powered by the motor, arranged within the minor segment so as to contact the suspended cable when received by the non-linear channel and thereby to drive the device along the suspended cable.

Preferably, the non-linear channel comprises an inflection point, the minor segment being defined by said inflection point, and wherein the drive mechanism is aligned with said inflection point. Optionally, at least a portion of the drive mechanism is coincidental upon the inflection point. Optionally, the drive mechanism is offset from the inflection point. Preferably, at least part of the drive mechanism is vertically and/or horizontally aligned with the inflection point. Preferably, the non-linear channel comprises only a single inflection point. Preferably, the driving mechanism is arranged to contact the suspended cable from below.

Preferably, the non-linear channel comprises a first channel and a second channel, and wherein said channels intersect so as to form the non-linear channel. Preferably, the non-linear channel comprises a non-linear intersection. Preferably, the first channel and the second channel intersect at the inflection point. Preferably, the first channel and the second channels intersect at an angle greater than 90 degrees, and less than 180 degrees, and more preferably between 140 and 170 degrees. Preferably, the non-linear channel is formed of a set of walls and/or rollers. Preferably, the non-linear channel is at least 4 mm wide, preferably 6 mm wide, and more preferably 8 mm wide, and may be no more than 20 mm wide. Preferably, the centre of gravity of the device is gravitationally aligned with or centred upon the inflection point. Preferably, longitudinally (or along the length of the device), the non-linear channel is v-shaped, hyperbolic or parabolic. Preferably, laterally (or across the width of the device), at least a portion of the non-linear channel comprises an L-shaped portion.

Preferably, the first and the second channels are linear channels, and more preferably at least as to their longitudinal extent. Preferably, the first and the second channels are symmetrical about at least one axis. Preferably, the first and the second channels have the same dimensions.

Preferably, the non-linear channel comprises a flange, wherein said flange defines a well (or, optionally, a pit, depression, or trench), and wherein the flange is arranged to retain the cable within, and to oppose the cable from being slotted out of the well. Optionally, the flange is provided only as part of the first channel. Preferably, the flange is arranged towards an exterior of the device relative to the well. Preferably, the well is at least as deep as the gauge of the cable. Optionally, the flange is configured to slope towards the well, and may be convexly curved.

Preferably, within the minor segment, the flange and/or the well extend/s in an opposite direction to a portion of the flange and/or the well that is/are arranged beyond the minor segment. Preferably, the flange and/or the well extend/s downwards, towards the drive wheel, within (or on the same side of) the minor segment. Preferably, the flange and/or well extend/s upwards, away from the drive wheel, beyond (or on an opposing side of) the minor segment. Preferably, the first and second channels both comprise the flange, and wherein the flanges extend in the same direction at, or proximate, distal terminal ends of the first and second channels.

Preferably, at least a portion of the non-linear channel is defined by a pair of side walls, wherein said side walls are parallel to one another or are inclined towards one another in a direction towards an interior of the device. Preferably, the pair of side walls are, at most, perpendicular to a floor of the well, or a most interior portion of the non-linear channel.

Preferably, the device further comprises a branching channel arranged to extend from the non-linear channel. Preferably, the branching channel extends: from the inflection point; in linear or parabolic prolongation of the non-linear channel, and/or optionally, specifically, the first channel. Preferably, the branching channel intersects with the second channel at an angle greater than zero degrees and less than ninety degrees, and more operably between 35 degrees and five degrees. Preferably, in profile, the non-linear and/or branching channel/s is/are, at least in part, L-shaped, that is, comprising a flange arranged to reduce the dimensions of the opening of the channel(s), thereby to constrain the cable. Preferably, the flange is arranged on an upper portion of the channel/s, and extends towards a lower portion of the channel/s.

Preferably, the device further comprising a ramp extending from the branching channel towards the second channel. Preferably, the ramp extends towards an exterior of the device, reaching a maximal external (or lateral) extremity closest the second channel. Preferably, the ramp defines at least a portion of the wall/s of the branching channel and/or second channel. Optionally, the ramp extends along the entire length of the branching channel and/or second channel. Optionally, the ramp is laterally and/or longitudinally curved or straight. Optionally, the ramp extends from a base, or a most interior portion, of the branching channel. Optionally, the angle of inclination and/or curvature of the ramp varies along the length (preferably, the longitudinal extent) of the ramp.

Preferably, the device further comprises at least one roller, wherein said at least one roller is arranged within the non-linear channel. Preferably, the at least one roller is arranged at a terminal end of the first and/or second channel. Preferably, the at least one roller is arranged to contact the suspended cable from above. Preferably, the roller is arranged on an opposite side of the non-linear channel to the driving mechanism.

According to another aspect of the invention, there is provided a mounting formation for coupling a device, for traversing a suspended cable anchored at each end, and the device comprising a powered drive mechanism, the mounting formation comprising: an open non-linear channel for receiving, by a slotting action, the suspended cable, said non-linear channel defining a minor segment, and for receiving the powered drive mechanism within the minor segment so as to contact the suspended cable when received by the non-linear channel and thereby to drive the device along the suspended cable.

Preferably, the device further comprises a cable coupling for coupling a cable or cord to the device, thereby for the device to pull said cable or cord. Preferably, the cable coupling is arranged at a rear of the device, distally to the direction of travel of the device along the suspended cable. Preferably, the cable coupling is provided on an external surface of the housing. Preferably, the cable coupling is a hook and/or clamp. Preferably, the device further comprises a wireless receiver and a processor for permitting remote control of, at least, the motor. Preferably, the device is configured such that at least half of the mass of the device is arranged below the suspended cable, and optionally within the minor segment, when said cable is received by the driving mechanism. Preferably, the motor is electric and/or mechanical. Preferably, the device further comprises a battery for powering the motor. Preferably, the device is self-powered and/or self-propelled.

Optionally, the device further comprises a compliant sealing member provided at an opening of the non-linear channel. The sealing member may be configured as a funnel extending towards an interior of the device.

Preferably, the drive mechanism comprises a drive wheel. Optionally, the drive wheel comprises a groove, or sheave, so as to receive the cable within the groove. Optionally, the driving mechanism comprises a plurality of drive wheels, wherein at least one of which is provided at or within the minor segment. Preferably, the driving mechanism and the motor are coupled to, and more preferably are engaged with, a housing of the device. To help ensure sufficient traction along low-friction telecommunications cables, and thereby help prevent slippage, the device comprises a weight so as to increase contact friction between the driving mechanism and the suspended cable received therein.

Preferably, the suspended cable is tensioned, slack or taught, and the anchored ends of the cable may be substantially at the same height. Preferably, the suspended cable is free-hanging. Preferably, the suspended cable is a telecommunications cable, and more preferably a dropwire or an aerial cable. Optionally, the suspended cable is a structural (e.g. steel) cable or an electrical power cable. Preferably, an external surface of the suspended cable is formed of metal, plastic, resin and/or rubber. Preferably, the suspended cable is (substantially) horizontally orientated, and not vertically orientated. Preferably, the non-linear channel and/or the branching channel are recessed within a housing or body of the device.

The invention includes any novel aspects described and/or illustrated herein. The invention also extends to methods and/or device substantially as herein described and/or as illustrated with reference to the accompanying drawings. To the extent appropriate, features described as being implemented in hardware may alternatively be implemented in software, and vice versa.

Any device feature may also be provided as a corresponding step of a method, and vice versa. As used herein, means plus function features may alternatively be expressed in terms of their corresponding structure, for example as a suitably-programmed processor.

Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently.

As used throughout, the word ‘or’ can be interpreted in the exclusive and/or inclusive sense, unless otherwise specified.

The invention extends to a device and a mounting formation as described herein and/or substantially as illustrated with reference to the accompanying drawings. The present invention is now described, purely by way of example, with reference to the accompanying diagrammatic drawings, in which:

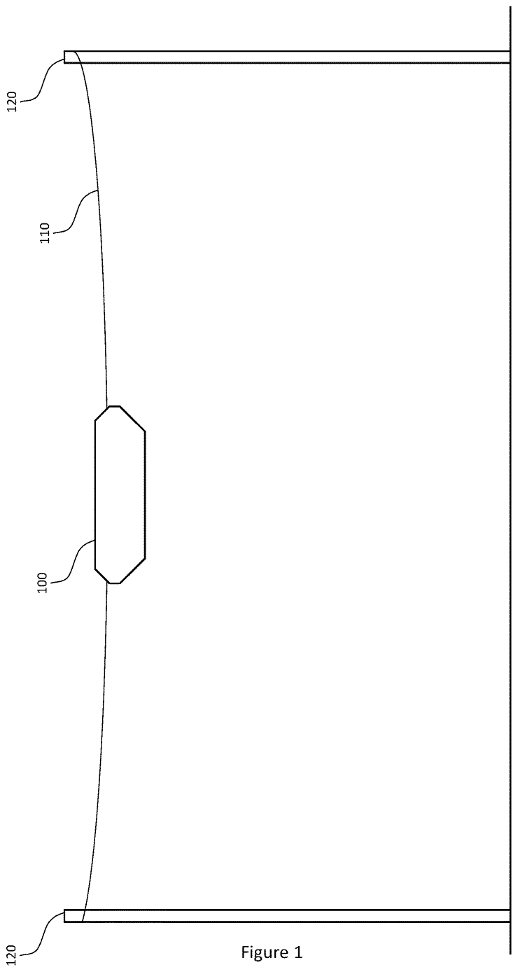

FIG. 1 shows a portion of a telecommunications network comprising a cable management device;

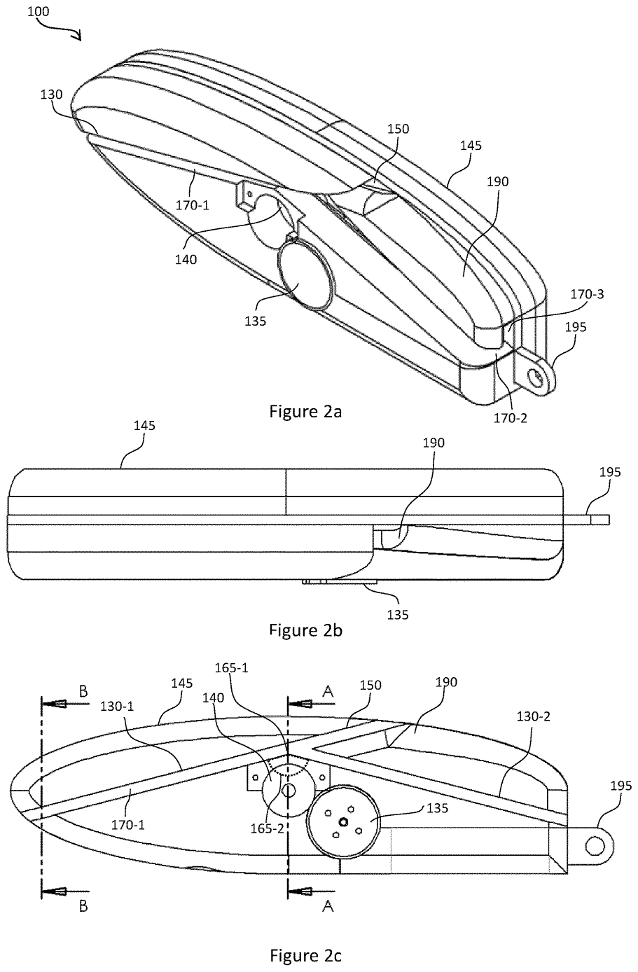

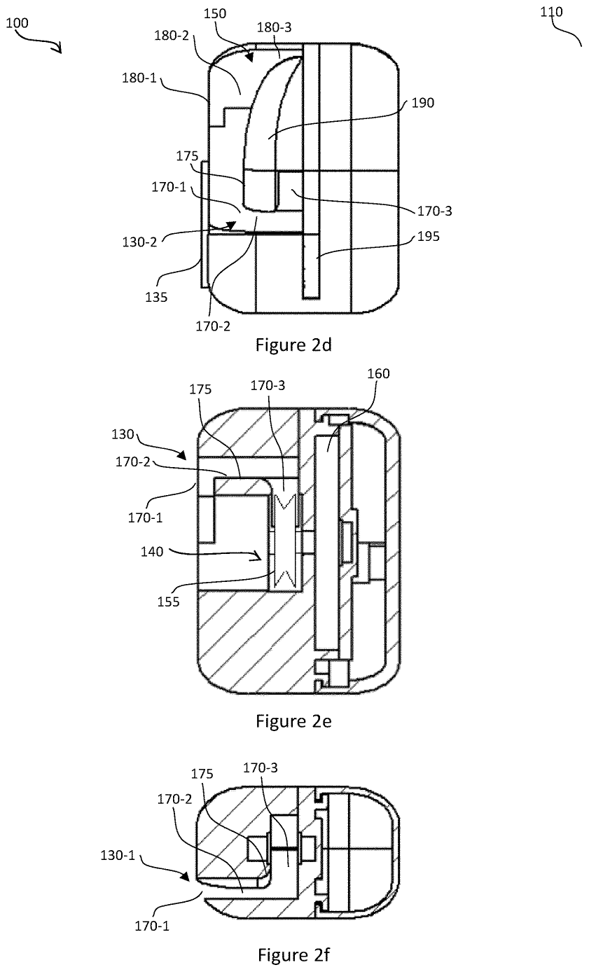

FIGS. 2a, 2b, 2c, 2d, 2e and 2f show various views of the cable management device in detail; and

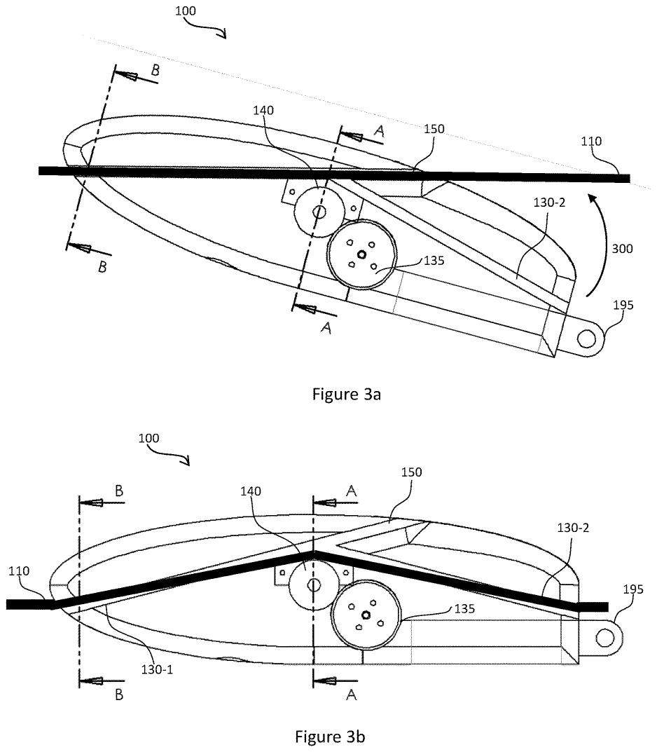

FIGS. 3a and 3b show the cable management device operated to mount a cable.

### SPECIFIC DESCRIPTION

FIG. 1 is a schematic diagram of a cable management device 100 shown in use as part of a fixed-access telecommunications network, which comprises an elevated suspended telecommunications cable (or dropwire) 110 and a pair of distribution points 120, for example in the form of a telegraph/telephone pole. The cable 110 is anchored at both ends to the distribution points 120, and is available to be in the form of an electrical conductor-based telecommunications cable (e.g. copper or aluminium), fibre optic cable, and/or a supporting structural cable.

The device 100 is configured to be mounted and secured onto the cable 110 while the cable remains anchored, and then to traverse the cable. In this way, the device is available to help perform maintenance and/or installation tasks without requiring an engineer to work at height or disconnection of the cable 110.

FIGS. 2a, 2b, 2c, 2d, 2e and 2f show various views of the cable management device 100 in more detail. In particular, FIG. 2a is a perspective view, FIG. 2b is a top view, FIG. 2c is a longitudinal side view, and FIG. 2d is a rear side view. FIGS. 2e and 2f are lateral cross-sectional views through planes A-A and B-B, respectively, as shown in FIG. 2c.

The device 100 comprises a/an: open non-linear channel 130; motor 135; drive mechanism 140; housing 145; and open branching channel 150.

The open non-linear channel 130 and the open branching channel 150 are provided as exposed troughs of the housing, and are suitably dimensioned to receive the cable 110.

The drive mechanism 140 and motor 135 are provided for locomoting the device 100 along the cable. In this example, the drive mechanism comprises a drive wheel 155 for contacting the cable 110, when received within the non-linear channel 130, and a transmission wheel 160 for imparting torque upon the drive wheel 155 from the motor via a drivetrain (not shown). As best shown in FIG. 2e, the drive wheel is in the form of a sheave.

The drive mechanism 140 is recessed within the housing 145 and is powered by the motor 135, which is in the form of an electric motor. To balance the device, weighty components of the device, including the drive mechanism 140 and motor 135, are arranged so that the centre of gravity aligns with the point of contact with the cable. That is, such weighty components are arranged vertically from the open non-linear channel 130. Furthermore, the weight components are arranged low on the device, and below the open non-linear channel 130.

As best shown in FIG. 2c, the open non-linear channel spans the entire length of the housing 145 (i.e. front to rear), and the cable is therefore available to be slotted into, and fed through, said channel, thereby allowing the device to receive the cable without having to thread through the device, and therefore detach, the cable.

The non-linear channel is formed of intersecting first 130-1 and second 130-2 channels. The first and second channels define, about a point of intersection 165-1 (coinciding with cutting plane A-A), a minor segment 165-2 (represented by a dashed line in FIG. 2c), which is the smaller of the angles bound by the first and second channels (and is to be contrasted with an opposing major segment). The angle of the minor segment is approximately 130 to 160 degrees.

As best shown in FIGS. 2d, 2e and 2f, the non-linear channel comprises a mouth 170-1, throat 170-2 and well 170-3. The mouth 170-1 provides an exposed, external and outward-facing aperture for receiving the cable. The mouth 170-1 is oversized relative to the gauge of the cable to permit ease of insertion. Towards an interior of the housing, the mouth transitions into the throat 170-2, which is defined by a flange 175. The throat is a duct extending from the mouth and into the interior of the housing 145 up to the well 170-3. The well is an enclosed walled chamber, defined, in part, by the flange 175, which forms a lip that is larger than the gauge of the cable so as to help retain the cable within the well. The mouth 170, throat 170-2 and well 170-3 are defined by substantially parallel walls extending into the interior of the housing, that present a bluff surface within which to contain the cable within the non-linear channel.

As best shown by comparing like features of FIGS. 2d, 2e and 2f, the lateral configuration of the mouth 170-1, throat 170-2 and well 170-3 vary along the length of the device.

At and towards a front of the device, as best shown in FIG. 2f, the mouth 170-1 and throat 170-3 are of substantially the same width, whereas the well is larger than both; together, these form a substantially L-shaped chamber. Here, the well only extends above the throat 170-2.

At the intersecting point 165-1, as best shown in FIG. 2e, the mouth 170-1 and the well 170-3 are oversized relative to the throat, with the well also being wider than the mouth 170-1. Both the mouth 170-1 and the well 170-3 only extend below the throat 170-2. The well 170-3 is arranged and dimensioned so as to extend up to the drive wheel 155, thereby to allow the cable to contact the drive wheel when the cable is in the well.

At and towards the rear, as best shown in FIG. 2d, the mouth 170-1 and the well 170-3 are oversized relative to the throat 170-2, with the mouth being significantly wider than the well. Both the mouth and the well only extend above the throat.

The mouth 170-1, throat 170-2 and well 170-3 continuously transition across the length of the device to form the different dimensions and orientations at the front, intersecting point and rear that are described above.

The flange 175 curves convexly from the throat to the well so as to help slip the cable through the throat and into the well. However, the bluff configuration and oversized dimension of the flange and well relative to the cable prevent the cable from easily, and unintentionally, slipping back out of the well.

As best shown in FIG. 2c, the branching channel 150 extends from the intersecting point 165-1 away from, and in prolongation of, the first channel 130-1, and up to a rear of the device. The angle between the first channel and the branching channel is therefore approximately 180 degrees; that is, the first channel and branching channel approximately form a linear channel. As such, the branching channel is a branch of the non-linear channel, and in combination, provides a linear channel spanning the entire length of the housing 145 (i.e. front to rear), and the cable is therefore available to be slotted into, and fed through, the first and branching channels, thereby allowing the device to receive the cable without having to thread through the device, and therefore detach, the cable

In a corresponding manner to the non-linear channel, the branching channel 150 comprises a mouth 180-1 forming an exposed aperture for receiving the cable, and a well 180-3 and a throat 180-2 extending therebetween. The mouth 180-1 is oversized relative to the throat 180-2. The well 180-3 and the second channel 130-2 are substantially vertically aligned, and are approximately arranged at a lateral midpoint of the device.

The mouth 180-1, throat 180-2 and well 180-2 are, in part, defined by a ramp 190. The ramp is a concave member extending longitudinally from a point of divergence between the second channel 130-2 and the branching channel 150 and up to a terminal end of the second channel at the rear of the device. The ramp also extends upwardly from the branching channel towards the second channel, at which point the ramp provides a bluff drop into the second channel. In this way, and as described in more detail below with reference to FIG. 3, the ramp allows a user to ramp the cable up and over from the branching channel and into the second channel so as to be retained therein.

To help allow convenient mounting of the device 100 onto the cable 110, as described in more detail below, the mouth 180-1, throat 180-2 and well 180-3 are substantially wider than those corresponding features 170 of the non-linear channel 130.

In profile, as best shown in FIG. 2c, the housing 145 has a lozenge or bullet-shaped front face (i.e. for a forward direction of travel); this convex form provides a streamlined shape that may help deflect, upwards and over the device, matter (such as overhanding vegetation) encountered as the device travels along the cable.

FIGS. 3a and 3b show different stages of manipulation of the device 100 by a user so as to mount the device onto the cable 110.

To do so, the device 100 is first orientated as shown in FIG. 3a, in which the device is tilted so as to align the cable 110 with both the first channel 130-1 and the branching channel 150. The device is then manoeuvred, via a slotting action, so that the cable is received, through the mouths 170-1, 180-1 and throats 170-2, 180-2, into the wells 170-3, 180-3.

Constrained within the well 170-3 of the first channel, by means of the flange 175 and the steep walls defining the well 170-3, the device is then pivoted about the point of intersection 165-1, lifting the rear of the device, as per the motion represented by arrow 300. The cable is therefore urged to rotate (anticlockwise, from the perspective of FIG. 3a) with the first linear channel 130-1, which is then deformed (into a zig-zag) between the front terminal end of the first channel and at the point of intersection 165-1. Whereas, because of the ramp 190, the cable is free to move out of the branching channel 150, up and over the ramp and towards the second channel. Once the cable surmounts the ramp, the cable falls into the mouth 170-1 of the second channel, from where the cable is guided through the throat 170-2 and into the well 170-3. Accordingly, the cable is now deformed so as to follow the end-to-end path of the non-linear channel, and specifically of the well 170-3.

The device 100 is secured to the cable 110 by the tension in the cable and the ensuing impingement of the cable (upwards) against the front and rear of the non-linear channel 130 and also (downwards) against the drive wheel 155. The tension of the cable therefore serves securely to couple the device to the cable, without threading the cable through the device and without moving parts. Furthermore, synergistically, the resulting tensioning against the drive wheel 155 increases friction, and therefore traction between the drive wheel and the cable.

The device further comprises a coupling formation (or mechanism) 195, such as a loop, arranged externally at a rear of the device. For example, a tether is available to be coupled to the coupling formation 195, thereby to allow a cable or a cord to be pulled by the device, for example to allow installation of a new overhead cable.

To control locomotion of the device, the device is further available to comprise a switch (not shown) for controlling activation of the motor, and/or a wireless receiver and controller (neither shown) to enable remote control of the motor.

### Alternatives and Modifications

Although the device 100 is described in the context of being used with a telecommunications cable 110, it will be appreciated that the device is available to be used with other forms of suspended cables, including structural (such as steel cables) and electric power lines.

To help the cable move through the impinging points of contact at the front and rear of the non-linear channel 130, the surface of said point are provided as a low friction or smooth surface and/or with rollers (not shown).

In an alternative, to further help improve traction, the drive wheel 155 is coupled to an urging member (not shown) for urging together the drive wheel 155 and the cable 110. For example, the drive wheel is mounted onto a spring for urging the drive wheel against (upwards towards) the cable.

Although the non-linear channel 130 is shown as comprising linear first 130-1 and second 130-2 channels, the non-linear channel is available to have a curved shape, and in particular a parabolic or hyperbolic shape, which may mimic the curvature of the cable. In this case, the point of intersection is an inflection point, a (local) maxima or a (local) minima.

Alternatively or additionally, the cable management device 100 is available to incorporate features as shown and described in co-pending UK Patent Application No. GB 2119128.3 (Applicant's reference: A35746GBp01), the contents of which are herein incorporated by reference.

Each feature disclosed herein, and (where appropriate) as part of the claims and drawings may be provided independently or in any appropriate combination.

Any reference numerals appearing in the claims are for illustration only and shall not limit the scope of the claims.

1. A device for traversing a suspended cable anchored at each end, and the device comprising:
an open non-linear channel for receiving, by a slotting action, the suspended cable, said non-linear channel defining a minor segment;
a motor; and
a drive mechanism, powered by the motor, arranged within the minor segment so as to contact the suspended cable when received by the non-linear channel and thereby to drive the device along the suspended cable.

2. A device according to claim 1, wherein the non-linear channel comprises an inflection point, the minor segment being defined by said inflection point, and wherein the drive mechanism is aligned with said inflection point.

3. A device according to claim 1, wherein the non-linear channel comprises a first channel and a second channel, and wherein said channels intersect so as to form the non-linear channel.

4. A device according to claim 3, wherein the first and the second channels are linear channels.

5. A device according to claim 1, wherein the non-linear channel comprises a flange, wherein said flange defines a well, and wherein the flange is arranged to retain the cable within and to oppose the cable from being slotted out of the well.

6. A device according to claim 5, wherein, within the minor segment, the flange and/or the well extend/s in an opposite direction to a portion of the flange and/or the well that is/are arranged beyond the minor segment.

7. A device according to claim 1, wherein at least a portion of the non-linear channel is defined by a pair of side walls, wherein said side walls are parallel to one another or are inclined towards one another in a direction towards an interior of the device.

8. A device according to claim 1, comprising a branching channel arranged to extend from the non-linear channel.

9. A device according to claim 8, further comprising a ramp extending from the branching channel towards the second channel.

10. A device according to claim 1, further comprising at least one roller, wherein said at least one roller is arranged within the non-linear channel.

11. A mounting formation for coupling a device, for traversing a suspended cable anchored at each end, and the device comprising a powered drive mechanism, the mounting formation comprising:
an open non-linear channel for receiving, by a slotting action, the suspended cable, said non-linear channel defining a minor segment, and for receiving the powered drive mechanism within the minor segment so as to contact the suspended cable when received by the non-linear channel and thereby to drive the device along the suspended cable.
